(19) United States
(12) Patent Application Publication
(10) Pub. No.: US 2021/0400852 A1
(43) Pub. Date: Dec. 23, 2021

(54) DISPLAY DEVICE

(71) Applicant: Samsung Display Co., Ltd., Yongin-si (KR)

(72) Inventor: Hwanjin KIM, Hwaseong-Si (KR)

(21) Appl. No.: 17/287,393

(22) PCT Filed: May 30, 2019
(86) PCT No.: PCT/KR2019/006513

§ 371 Date: Apr. 21, 2021

(30) Foreign Application Priority Data
Nov. 6, 2018 (KR) 10-2018-0135261

(51) Int. Cl. H05K 7/20; H05B 3/34; G01K 3/00; G01K 7/22; G01K 1/14; G06F 1/16; G06F 21/44

(52) U.S. Cl. CPC H05K 7/20954; H05B 3/34; G01K 3/005; G06K 9/00013; G01K 1/14; G06F 1/1641; G06F 21/44; G01K 7/22

(57) ABSTRACT

A display device includes a display panel on which a folding area is defined, a case member, a temperature sensor for sensing a temperature, and a heating part disposed on an area overlapping the folding area in a plan view to operate when a measurement temperature measured in the temperature sensor is less than a predetermined temperature.

### CROSS-REFERENCE TO RELATED APPLICATIONS

This application claims priority to Korean Patent Application No. 10-2018-0135261, filed on Nov. 6, 2018, and all the benefits accruing therefrom under 35 U.S.C. § 119, the content of which in its entirety is herein incorporated by reference.

### TECHNICAL FIELD

The present invention relates to a display device, and more particularly, to a display device having improved durability.

### BACKGROUND ART

A display device displays various images on a display screen and provides information to a user. In general, the display device displays information within an assigned screen. In recent years, flexible display devices including a foldable flexible display panel have been developed. The flexible display device may be folded, rolled, or bent unlike a rigid display device. The flexible display device, which is variously changeable in shape, may be carried regardless of a typical screen size to thus improve convenience of a user.

A portion of materials contained in the flexible display device may be changed in modulus or flexibility. For example, a portion of the materials may increase in modulus and decrease in flexibility at a low temperature. Thus, when a shape of the flexible display device is deformed at the low temperature, a crack may be generated in a portion of components constituting the flexible display device.

### DISCLOSURE OF THE INVENTION

### Technical Problem

An aspect of the present disclosure is to provide a display device having improved durability.

### Technical Solution

A display device according to an embodiment of the present invention includes a window, a case member disposed below the window and foldable, a display panel disposed between the window and the case member and in which a folding area is defined, a temperature sensor disposed between the window and case member to sense a temperature, and a heating part disposed on an area which overlaps the folding area in a plan view. The heating part is configured to operate when a measurement temperature measured in the temperature sensor is less than a predetermined temperature.

The window may include a first window film and a second window film disposed below the first window film, and the heating part may be disposed between the first window film and the second window film.

The display device may further include a sensing unit disposed between the display panel and the window and including a sensing base layer and a sensing electrode, and the heating part may be disposed on one surface of the sensing base layer.

The display device may further include a sensing unit disposed between the display panel and the window and including a sensing base layer and a sensing electrode, and the sensing electrode and the heating part may be disposed in the same layer.

The heating part may be disposed on one surface of the display panel.

The heating part may include a first heating part and a second heating part, the first heating part may be disposed on the display panel, and the second heating part may be disposed below the display panel.

The first heating part may have a temperature greater than a temperature of the second heating part when the display panel is changed from a first state that the display device is folded to a second state that the display device is unfolded, and the first heating part may have a temperature lower than a temperature of the second heating part when the display panel is changed from the second state to the first state.

The display device may further include an authentification sensor which obtains authentification information, and the heating part may operate according to the measurement temperature when the authentification sensor obtains the authentification information.

The case member may include a locking device, and the locking device may lock the case member when the measurement temperature is less than the predetermined temperature.

The heating part may be a transparent surface heater, and the temperature sensor may be a thermistor.

The display device may further include a cooling part disposed on an area that overlaps the folding area in the plan view.

The heating part may include a first heating part and a second heating part, the first heating part may be disposed on the display panel, the second heating part may be disposed below the display panel, the cooling part may include a first cooling part and a second cooling part, the first cooling part may be disposed on the display panel, and the second heating part may be disposed below the display panel.

The first heating and the second cooling part may operate when the display panel is changed from a first state that the display device is folded to a second state that the display device is unfolded, and the second heating part and the first cooling part may operate when the display panel is changed from the second state to the first state.

A display device according to an embodiment of the present invention includes a case member, a flexible display panel accommodable in the case member, a temperature sensor disposed in the case member, an authentification sensor disposed in the case member, and a heating part disposed in the case member, and the heating part operates when the authentification sensor obtains the authentification information, and the measurement temperature measured in the temperature sensor is less than a predetermined temperature.

The display device may further include a rotation member disposed in the case member to roll the flexible display panel, and the heating part may be disposed in the rotation member.

An opening through which the flexible display panel enters may be defined in the case member, and the heating part may be disposed on an inner wall of the case member.

A folding area, a first display area, and a second display area may be defined on the flexible display panel, the first display area and the second display area may be spaced apart from each other with the folding area therebetween, and the heating part may be disposed adjacent to the folding area.

The case member may include a first case part which supports the first display area, a second case part which supports the second display area, and a lock device which couples the first case part and the second case part, and the lock device may lock the first case part and the second case part when the measurement temperature is less than the predetermined temperature in a folded state of the flexible display panel.

A display device according to an embodiment of the present invention includes a flexible display panel, a temperature sensor which measures a temperature, a heating part which operates according to the measured temperature, and a coupling member coupled with the flexible display panel and locked when the measured temperature is less than a predetermined temperature.

The display device may further include an authentification sensor which obtains authentification information, and the heating part may operate according to the measured temperature when the authentification sensor obtains the authentification information.

### Advantageous Effects

According to an embodiment of the present invention, the heating part may operate according to the temperature measured in the temperature sensor. Thus, even when the display device is used in the low temperature environment, the area corresponding to the folding area may maintain the value equal to or greater than the predetermined temperature by the heating part. As a result, a crack may be prevented from being generated in the components of the display device when the display device is folded or unfolded.

Also, the driving unit of the display device may determine whether a voltage is provided to the heating part according to the temperature of the temperature sensor after the user authentification information is obtained. That is, since the voltage is provided to the heating part only when the state change of the display device is expected, the power consumption may decrease.

When the measurement temperature is less than the reference temperature, the case member may be locked. That is, when a crack is expected to be generated in the low temperature condition, the case member may not be opened. Thus, the deformation of the display device in the low temperature environment may be prevented, and thus a crack may not be generated in the components of the display device.

### BRIEF DESCRIPTION OF THE DRAWINGS

FIG. 1 is a perspective view of a display device according to an embodiment of the present invention.

FIG. 2 is a perspective view of a display device according to an embodiment of the present invention.

FIG. 3 is a cross-sectional view of a display device according to an embodiment of the present invention.

FIG. 4 is a cross-sectional view illustrating partial components of a display device according to an embodiment of the present invention.

FIG. 5 is a cross-sectional view illustrating partial components of the display device according to an embodiment of the present invention.

FIG. 6 is a cross-sectional view illustrating a heating part and taken along line I-I′ in FIG. 5.

FIG. 7 is a cross-sectional view illustrating partial components of a display device according to an embodiment of the present invention.

FIG. 8 is a cross-sectional view illustrating partial components of a display device according to another embodiment of the present invention.

FIG. 9 is a cross-sectional view illustrating partial components of a display device according to still another embodiment of the present invention.

FIG. 10 is an enlarged plan view illustrating partial components of the display device from FIG. 9.

FIG. 11 is a cross-sectional view illustrating partial components of a display device according to yet another embodiment of the present invention.

FIG. 12 is a cross-sectional view illustrating partial components of a display device according to another embodiment of the present invention.

FIG. 13 is a cross-sectional view illustrating partial components of a display device according to still another embodiment of the present invention.

FIG. 14 is a cross-sectional view illustrating a first state of the display device according to an embodiment of the present invention.

FIG. 15 is a cross-sectional view illustrating a second state of the display device according to an embodiment of the present invention.

FIG. 16 is a cross-sectional view illustrating partial components of a display device according to yet another embodiment of the present invention.

FIG. 17 is a cross-sectional view illustrating a first state of the display device according to an embodiment of the present invention.

FIG. 18 is a cross-sectional view illustrating a second state of the display device according to an embodiment of the present invention.

FIG. 19A is an enlarged perspective view illustrating a first fixing part.

FIG. 19B is an enlarged perspective view illustrating a second fixing part.

FIG. 20 is a flowchart representing a method for controlling a display device according to an embodiment of the present invention.

FIG. 21 is a flowchart representing a method for controlling a display device according to an embodiment of the present invention.

FIG. 22 is a flowchart representing a method for controlling a display device according to an embodiment of the present invention.

FIG. 23 is a perspective view of a display device according to an embodiment of the present invention.

FIG. 24 is a cross-sectional view of the display device according to the embodiment of FIG. 23.

FIG. 25 is a cross-sectional view of a display device according to another embodiment of the present invention.

FIG. 26 is a cross-sectional view of a display device according to still another embodiment of the present invention.

### DETAILED DESCRIPTION

In this specification, it will be understood that when an element such as a region, layer, or portion is referred to as being “on” another element, it can be directly on the other element or intervening elements may also be present.

Like reference numerals refer to like elements throughout. Also, in the figures, the thickness, ratio, and dimensions of components are exaggerated for clarity of illustration.

The term “and/or” includes any and all combinations of one or more of the associated listed items.

It will be understood that although the terms of first and second are used herein to describe various elements, these elements should not be limited by these terms. The terms are only used to distinguish one component from other components. For example, a first element referred to as a first element in one embodiment can be referred to as a second element in another embodiment. The terms of a singular form may include plural forms unless referred to the contrary.

Also, ““under”, “below”, “above’, “upper”, and the like are used for explaining relation association of components illustrated in the drawings. The terms are relative concepts and described with respect to the direction indicated in the drawings.

Unless otherwise defined, all terms (including technical and scientific terms) used herein have the same meaning as generally understood by those skilled in the art. Terms as defined in a commonly used dictionary should be construed as having the same meaning as in an associated technical context, and unless defined apparently in the description, the terms are not ideally or excessively construed as having formal meaning.

The meaning of ‘include’ or ‘comprise’ specifies a property, a fixed number, a step, an operation, an element, a component or a combination thereof, but does not exclude other properties, fixed numbers, steps, operations, elements, components or combinations thereof.

Hereinafter, embodiments of the present invention will be described with reference to the accompanying drawings.

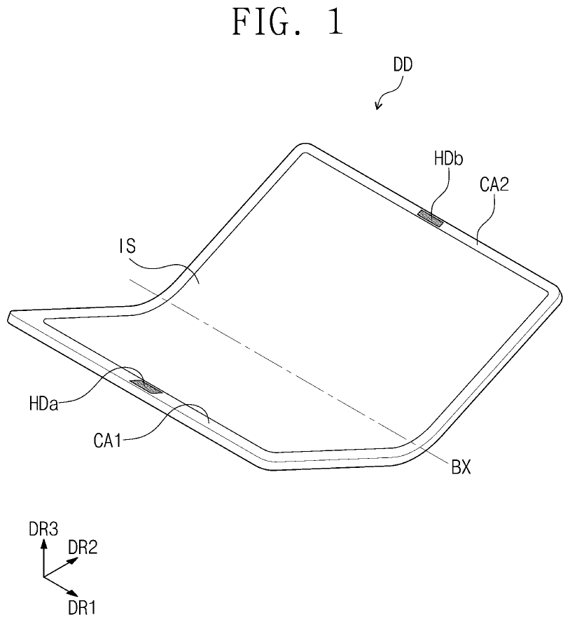

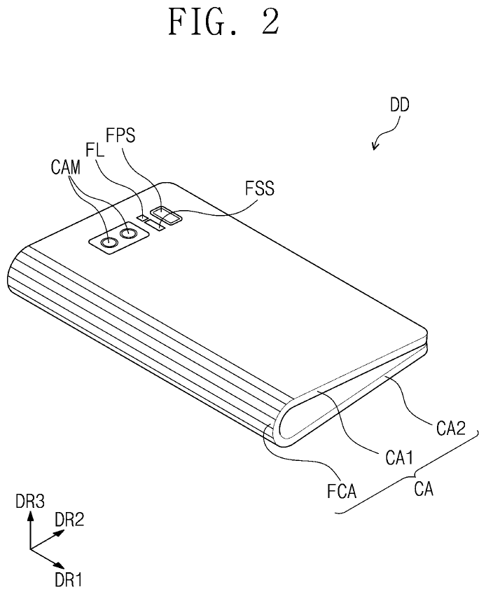

FIG. 1 is a perspective view of a display device according to an embodiment of the present invention, and FIG. 2 is a perspective view of a display device according to an embodiment of the present invention.

A display device DD of FIG. 1 and a display device DD of FIG. 2 may be the same display device. FIG. 1 illustrates a partially folded state of the display device DD, and FIG. 2 illustrates a completely folded state of the display device DD.

Referring to FIGS. 1 and 2, the display device DD may be a foldable display device. The display device DD according to the present invention may be used for large-sized electronic devices such as televisions and monitors and small and middle-sized electronic devices such as mobile phones, tablet computers, navigation units for vehicles, game consoles, and smart watches.

The display device DD may display an image through a display surface IS. The display surface IS may have a deformable shape according to a folded degree of the display device DD. For example, the display device DD may be folded with respect to a folding axis BX extending in a first direction DR1.

The display device DD may include a case member CA. The case member CA may be disposed at an outermost of the display device DD and accommodate components therein. The case member CA may include a first case part CA1, a second case part CA2, and a folding case part FCA. The folding case part FCA may be disposed between the first case part CA1 and the second case part CA2. The folding case part FCA may include a hinge structure or a flexible material. Thus, the folding case part FCA may have a shape deformable (e.g., foldable) in correspondence to a shape of the display device DD.

A first fixing part HDa may be disposed in the first case part CA1, and a second fixing part HDb may be disposed in the second case part CA2. Each of the first fixing part HDa and the second fixing part HDb may be referred to as a locking device. In a state illustrated in FIG. 2, the first case part CA1 and the second case part CA2 may be coupled by the first fixing part HDa and the second fixing part HDb.

The display device DD may further include a camera CAM, a flash FL, a fingerprint sensor FPS, and a functional sensor FSS. Each of the camera CAM, the flash FL, the fingerprint sensor FPS, and the functional sensor FSS may be exposed by a hole defined in the case member CA. The functional sensor FSS may be a proximity sensor, a color density detection sensor, an illumination sensor, a motion sensor, or a heat beat sensor. However, this is merely an example, and the functional sensor FSS according to the invention is not limited to the above examples. Also, a portion of the camera CAM, the flash FL, the fingerprint sensor FPS, and the functional sensor FSS may be omitted in another embodiment.

The display device DD may obtain user authentification information through the camera CAM, the fingerprint sensor FPS, and the functional sensor FSS. Thus, each of the camera CAM, the fingerprint sensor FPS, and the functional sensor FSS may be referred to as an authentification sensor. When the user authentification information is obtained, a subsequent operation such as an operation of releasing lock of the display device DD may occur.

An arrangement position of each of the camera CAM, the flash FL, the fingerprint sensor FPS, and the functional sensor FSS may be varied according to design, and is not limited to the example illustrated in FIG. 2.

Although the display device DD is in-folded with respect to the folding axis BX as an example in FIGS. 1 and 2, the present invention is not limited thereto. For example, in another embodiment of the present invention, the display device may be out-folded with respect to the folding axis BX. Referring to FIGS. 1 and 2, “in-folded” state means a state that opposing two parts of the display surfaces IS with respect to the folding axis face each other.

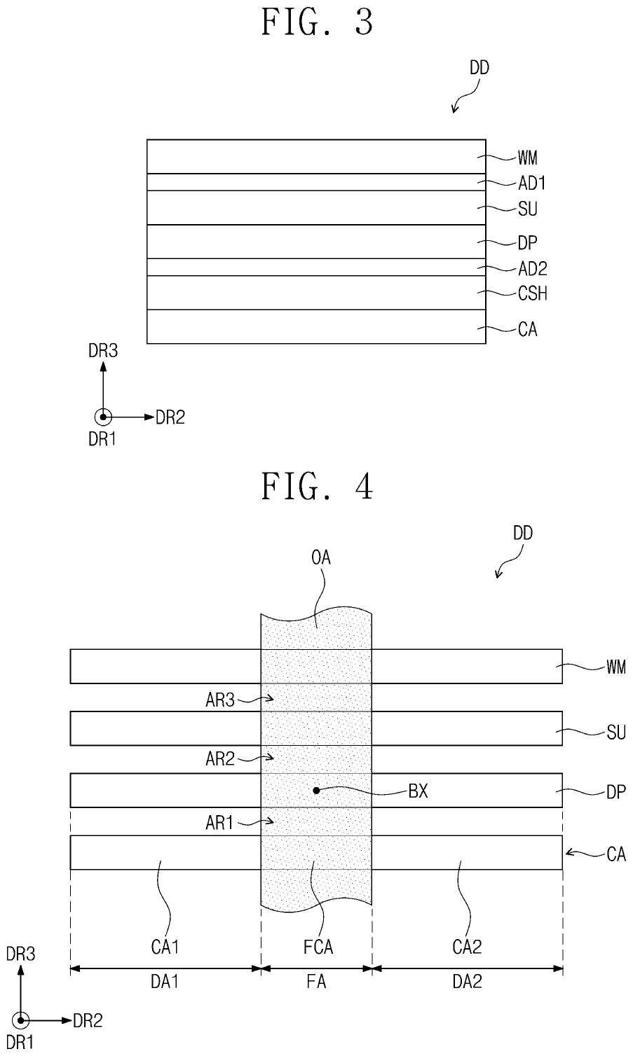

FIG. 3 is a cross-sectional view of a display device according to an embodiment of the present invention. FIG. 3 illustrates a cross-section defined by a second direction DR2 and a third direction DR3.

The display device DD may include a window WM, a display panel DP, a sensing unit SU, a cushion layer CSH, a case member CA, and adhesive layers AD1 and AD2. The plurality of adhesive layers AD1 and AD2 may include a first adhesive layer AD1 and a second adhesive layer AD2.

The display device DD may have a structure in which the window WM, the first adhesive layer AD1, the sensing unit SU, the display panel DP, the second adhesive layer AD2, the cushion layer CSH, and the case member CA are sequentially laminated. However, this is merely an example, and the display device DD may further include at least one functional layer and at least one adhesive layer.

For example, the display device DD may further include at least one of an impact absorption functional layer disposed between the display panel DP and the cushion layer CSH to absorb an impact, a light shielding functional layer for shielding light, a heat dissipation functional layer for dissipating heat, and an EMI shielding layer for blocking electromagnetic noise.

Each of the first adhesive layer AD1 and the second adhesive layer AD2 may be an optically clear adhesive film, an optically clear resin, or a pressure sensitive adhesive film. However, in another embodiment of the present invention, at least a portion of the first adhesive layer AD1 and the second adhesive layer AD2 may be omitted.

The first adhesive layer AD1 may be disposed between the window WM and the sensing unit SU and bonded to each of the window WM and the sensing unit SU. The second adhesive layer AD2 may be disposed between the window WM and the cushion layer CSH and bonded to each of the window WM and the cushion layer CSH.

The window WM may be disposed at an outermost surface of the display device DD. The window WM may include a flexible material. The window WM may include at least one of polyimide (“PI”), polyamideimide (“PAI”), polyether ether keton (“PEEK”), polyetherimide (“PEI”), and glass. However, this is merely an example, and the material of the window WM is not limited thereto.

The display panel DP may display an image. The display panel DP may be flexible. Thus, a shape of the display panel DP may be variously deformable. For example, the display panel DP may be folded or curved.

The sensing unit SU may be disposed on the display panel DP to sense a touch and/or a pressure applied from the outside.

The sensing unit SU may include a circuit for detecting a touch. A touch detecting method of the sensing unit SU includes a resistive layer method, an optical method, a capacitive method, and an ultrasonic method, but the touch detecting method is not limited thereto. Among the above-described methods, a capacitive sensing unit SU may detect whether a touch is generated by using capacitance that is varied when a touch generation unit contacts a screen of the display device DD. The capacitive method may be classified into a mutual capacitive method and a self capacitive method.

The sensing unit SU may be directly disposed on the display panel DP. The expression of “being directly disposed” represents a feature of being formed by a continuous manufacturing process excluding a feature of being bonded by using a separate adhesive member. However, the present invention is not limited thereto, and the display panel DP and the sensing unit SU may be coupled to each other by using an adhesive member (not shown).

The cushion layer CSH may be disposed below the display panel DP. The cushion layer CSH may include a polymer material. The cushion layer CSH may be a layer for absorbing an impact applied from the outside. In an embodiment of the present invention, the cushion layer CSH may be omitted.

The case member CA may be disposed below the cushion layer CSH. The case member CA may accommodate the sensing unit SU, the display panel DP, the cushion layer CSH, and the camera CAM, the fingerprint sensor FPS, and the functional sensor FSS, which are illustrated in FIG. 2.

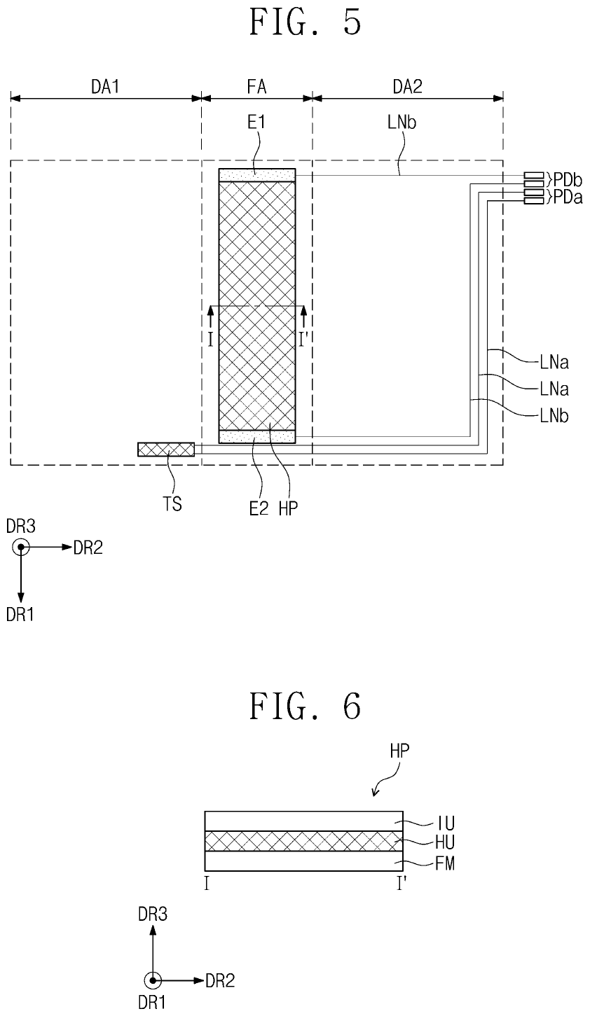

FIG. 4 is a cross-sectional view illustrating partial components of the display device according to an embodiment of the present invention. FIG. 5 is a cross-sectional view illustrating partial components of the display device according to an embodiment of the present invention.

Referring to FIGS. 4 and 5, a folding area FA folded with respect to the folding axis BX, and a first display area DA1 and a second display area DA2, which are spaced apart from each other with the folding area FA therebetween, may be defined in the display panel DP.

The first case part CA1 of the case member CA may be disposed in the first display area DA1. The second case part CA2 of the case member CA may be disposed in the second display area DA2. The folding case part FCA of the case member CA may be disposed in the folding area FA.

In FIG. 4, an overlap area OA that overlaps the folding area FA of the display panel DP on a plane (i.e., in a plan view) is darkly illustrated. The overlap area OA may be an area overlapping the folding area FA when viewed in the third direction DR3 (i.e., in a plan view).

The display device DD may include a temperature sensor TS and a heating part HP.

The temperature sensor TS may be an element for measuring a temperature, e.g., a thermistor. The temperature sensor TS may have a resistance varied according to a temperature. Thus, a temperature may be measured through the temperature sensor TS. The temperature measured by the temperature sensor TS will be referred to as a measurement temperature. The temperature sensor TS may be a negative temperature coefficient (“NTC”) thermistor or a positive temperature coefficient (“PTC”) thermistor.

The temperature sensor TS may be connected to pad parts PDa through lines LNa. Although not shown, the pad parts PDa may be electrically connected to a driving unit of the display panel DP.

The heating part HP may be a transparent surface heater. The heating part HP may be disposed between a first electrode E1 and a second electrode E2. The first electrode E1 may be a positive electrode, and the second electrode E2 may be a negative electrode. A certain voltage may be applied to the heating part HP by the first electrode E1 and the second electrode E2. As the voltage is applied, a temperature of the heating part HP may increase. In this specification, a feature in which the temperature of the heating part HP increases as the voltage is applied to the heating part HP will be expressed as a feature in which the heating part HP operates. Each of the first electrode E1 and the second electrode E2 may include at least one of gold (Au), platinum (Pt), silver (Ag), aluminum (Al), copper (Cu), zinc (Zn), nickel (Ni), titanium nitride (TiN), or tantalum nitride (TaN), but the material of the first electrode E1 and the second electrode E2 is not limited thereto.

The first electrode E1 and the second electrode E2 may be connected to pad parts PDb through lines LNb. The pads PDb may be electrically connected to the driving unit of the display panel DP.

In an embodiment of the present invention, the heating part HP may be disposed on the overlap area OA overlapping the folding area FA. Thus, the heating part HP may increase a temperature of components disposed on the area overlapping the folding area FA among the components of the display device DD in a plan view.

Although the temperature sensor TS is disposed on the area overlapping the first display area DA1 as an example in FIG. 5, the present invention is not limited thereto. For example, the temperature sensor TS may be disposed on an area overlapping the second display area DA2 or an area overlapping the folding area FA.

The heating part HP may operate when the measurement temperature measured by the temperature sensor TS is less than a predetermined temperature. For example, the predetermined temperature may be about 0 degrees in Celsius)(°. However, this is merely an example, and the predetermined temperature may be changed according to a design condition of the display device DD.

A modulus of the window WM or the display panel DP may increase in a low temperature environment, e.g., an environment of about 40° below zero (i.e., minus 40°). In this case, when the shape of the display device DD is deformed, e.g., when the display device DD is folded, a crack may be generated in the window WM or the display panel DP, and this may cause a product defect. However, according to an embodiment of the present invention, the heating part HP may operate when the measurement temperature is less than a predetermined temperature. The feature in which the heating part HP operates represents that the temperature of the heating part HP increases as a voltage is applied to the heating part HP. When the heating part HP operates, a temperature of each of the components disposed on the overlap area OA may increase. Thus, although the shape of the display device DD is deformed (e.g., folded) at the low temperature environment, a limitation in which the crack is generated in the window WP or the display panel DP may be prevented. That is, durability of the display device DD may improve.

A position of the heating part HP may be variously changed. For example, the heating part HP may be disposed on a first area AR1 between the display panel DP and the case member CA, a second area AR2 between the display panel DP and the sensing unit SU, or a third area AR3 between the sensing unit SU and the window WM. However, this is merely an example, and the position of the heating part HP is not limited thereto. For example, the heating part HP may be contained in the window WM, the sensing unit SU, or the display panel DP.

The temperature sensor TS may be disposed at the same position as the heating part HP. However, the present invention is not limited thereto, and the temperature sensor TS may be disposed at a position different from the heating part HP. For example, when the window WM is the most vulnerable to a crack in the low temperature environment, the temperature sensor TS may be disposed between the window WM and the sensing unit SU or contained in the window WM. The heating part HP may be contained in the sensing unit SU. In this case, heat may be generated by the heating part HP contained in the sensing unit SU, and the heating part HP may continuously operate until the window WM reaches to a predetermined temperature.

FIG. 6 is a cross-sectional view illustrating the heating part and taken along line I-I′ in FIG. 5.

Referring to FIG. 6, the heating part HP may include a film FM, a heating layer HU, and an insulation layer IU.

The film FM may include a material that is transparent and thermally resistant. For example, the film FM may include at least one of polyethylene terephthalate (“PET”), polycarbonate (“PC”), polymethyl methacrylate (“PMMA”), polyethylenenaphthelate (“PEN”), polyethersulfone (“PES”), cycloolefin copolymer (“COC”), cellulose triacetate (“TAC”), polyvinyl alcohol (“PVA”), polyimide (PI), or glass.

The heating layer HU may be disposed on the film FM. The heating layer HU may include a mixture having an electrode and a resistance. For example, the electrode may include indium tin oxide (“ITO”), silver nano-wire (AgNW), or a carbon nano-tube (CNT). The electrode may have an optically clear property. The mixture may be nano-sized graphite. However, this is merely an example, and the material of the electrode and the mixture is not limited thereto.

The insulation layer IU may be disposed on the heating layer HU. The insulation layer IU may include silicon or acryl.

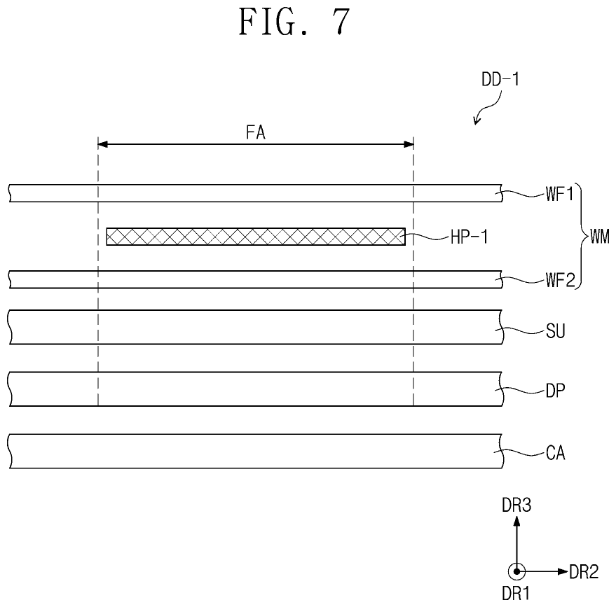

FIG. 7 is a cross-sectional view illustrating partial components of a display device according to an embodiment of the present invention.

Referring to FIG. 7, a display device DD-1 may include a window WM, a sensing unit SU, a display panel DP, a case member CA, and a heating part HP-1.

The window WM may include a first window film WF1 and a second window film WF2. The heating part HP-1 may be disposed between the first window film WF1 and the second window film WF2. For example, the heating part HP-1 may be bonded to the first window film WF1 or the second window film WF2.

An adhesive layer (not shown) may be disposed between the first window film WF1 and the second window film WF2. The adhesive layer may be an optically clear adhesive film, an optically clear resin, or a pressure sensitive adhesive film. However, this is merely an example, and the material of the adhesive layer is not limited thereto.

Each of the first window film WF1 and the second window film WF2 may include at least one of polyimide (PI), polyamideimide (PAI), polyether ether keton (PEEK), and polyetherimide (PEI). However, this is merely an example, and the material of each of the first window film WF1 and the second window film WF2 is not limited thereto. In an embodiment of the present invention, the first window film WF1 and the second window film WF2 may include the same material as each other or different materials from each other. For example, each of the first window film WF1 and the second window film WF2 may include a material having a different modulus.

A tensile force may be generated in a component disposed at an outermost portion among components of the display device DD-1. For example, a tensile force may be generated in the first window film WF1. According to an embodiment of the present invention, the heating part HP-1 may be disposed adjacent to the first window film WF1. Thus, the heating part HP-1 may increase a temperature of the first window film WF1, and as a result, a modulus of the first window film WF1 may decrease, and an elongation (or flexibility) of the first window film WF1 may improve. Thus, a probability of a crack generated in the window WM may decrease.

Also, in another embodiment of the present invention, the heating part HP-1 may be bonded to a bottom surface (in other words, rear surface) of the second film WF2. The bottom surface may be one surface of the second film WF2, which faces the sensing unit SU.

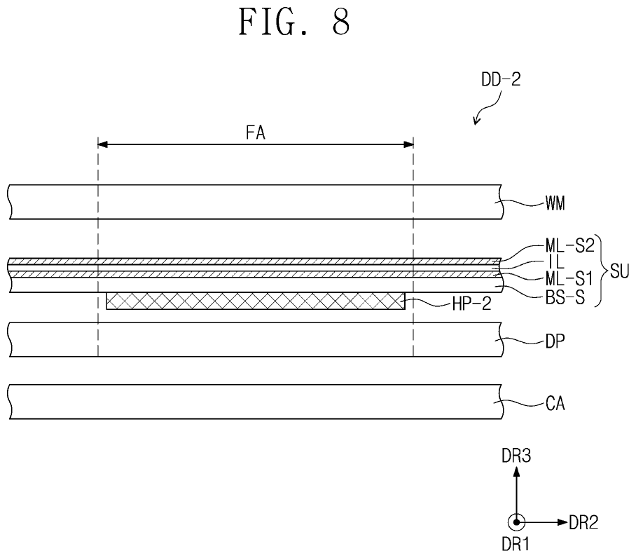

FIG. 8 is a cross-sectional view illustrating partial components of a display device according to another embodiment of the present invention.

Referring to FIG. 8, a display device DD-2 may include a window WM, a sensing unit SU, a display panel DP, a case member CA, and a heating part HP-2.

The sensing unit SU may include a sensing base layer BS-S, a first conductive layer ML-S1, an insulation layer IL, and a second conductive layer ML-S2. Each of the first conductive layer ML-S1 and the second conductive layer ML-S2 may include at least a portion of sensing electrodes, connection lines for connecting the sensing electrodes, and signal lines.

The heating part HP-2 may be disposed on one surface of the sensing base layer BS-S. For example, the heating part HP-2 may be disposed on one surface (e.g., bottom surface) of the sensing base layer BS-S, which faces the display panel DP. The lines LNb (refer to FIG. 5) connected to the heating part HP-2 may be provided on one of the first conductive layer ML-S1 and the second conductive layer ML-S2.

An adhesive layer (not shown) may be disposed between the sensing base layer BS-S and the display panel DP. In another embodiment of the present invention, the heating part HP-2 may be disposed on a top surface of the insulation layer IL.

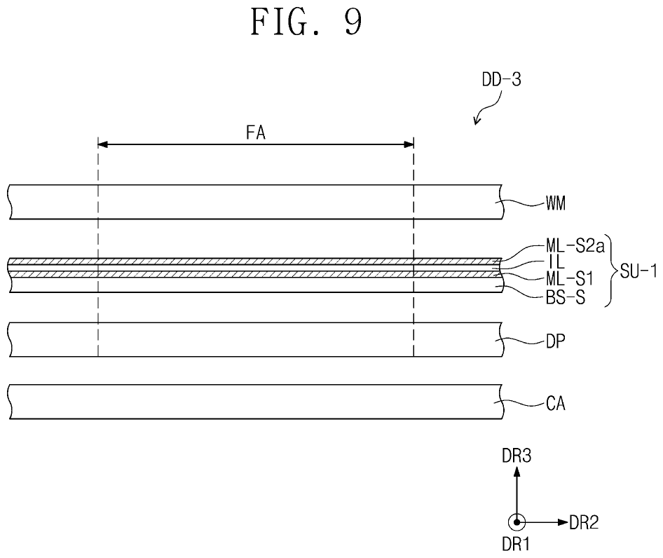

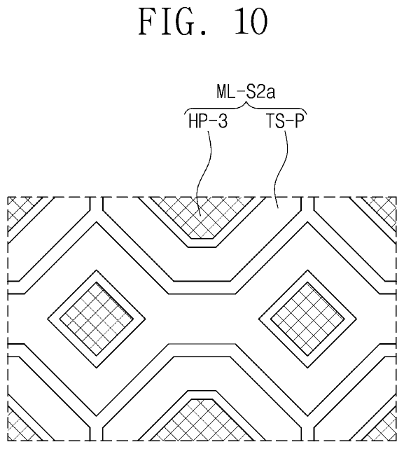

FIG. 9 is a cross-sectional view illustrating partial components of a display device according to still another embodiment of the present invention. FIG. 10 is an enlarged plan view illustrating partial components of the display device from FIG. 9.

Referring to FIGS. 9 and 10, a display device DD-3 may include a window WM, a sensing unit SU-1, a display panel DP, and a case member CA.

The sensing unit SU-1 may include a sensing base layer BS-S, a first conductive layer ML-S1, an insulation layer IL, and a second conductive layer ML-S2a.

The second conductive layer ML-S2a may include a heating part HP-3 and sensing electrodes TS-P. In an embodiment of the present invention, the heating part HP-3 and the sensing electrodes TS-P may be disposed in the same layer as each other. For example, the heating part HP-3 and the sensing electrodes TS-P may be disposed on the insulation layer IL. The heating part HP-3 and the sensing electrodes TS-P may be spaced apart with a predetermined gap from each other on the plane (in a plan view).

Although the second conductive layer ML-S2a includes the heating part HP-3 as an example in FIGS. 9 and 10, the present invention is not limited thereto. For example, the heating part HP-3 may be contained in the first conductive layer ML-S1 in another embodiment.

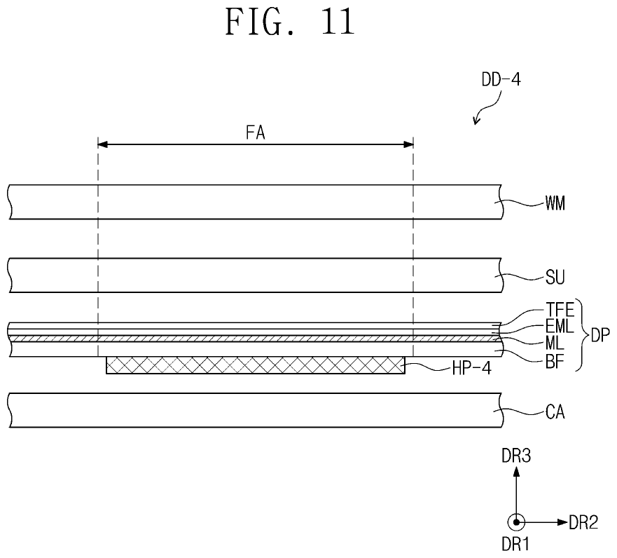

FIG. 11 is a cross-sectional view illustrating partial components of a display device according to yet another embodiment of the present invention.

Referring to FIG. 11, a display device DD-4 may include a window WM, a sensing unit SU, a display panel DP, a case member CA, and a heating part HP-4.

The display unit DP includes a base layer BF, a circuit layer ML, a light emitting element layer EML, and a thin-film encapsulation layer TFE. Although an organic light emitting display panel is described as an example of the display panel DP in this specification, the present invention is not particularly limited thereto.

The base layer BF may be a laminated structure including a silicon substrate, a plastic substrate, a glass substrate, an insulation film, or a plurality of insulation layers.

The circuit layer ML may be disposed on the base layer BF. The circuit layer ML may include a plurality of insulation layers, a plurality of conductive layers, and a semiconductor layer.

The light emitting element layer EML may be disposed on the circuit layer ML. The light emitting element layer EML includes a display element such as organic light emitting diodes. However, the present invention is not limited thereto, and the light emitting element layer EML may include inorganic light emitting diodes or organic-inorganic hybrid light emitting diodes according to the kind of display panel DP.

The thin-film encapsulation layer TFE seals the light emitting element layer EML. The thin-film encapsulation layer TFE includes a plurality of inorganic layers and at least one organic layer disposed therebetween. The inorganic layers protect the light emitting element layer EML from moisture and oxygen, and the organic layer protects the light emitting element layer EML from foreign substances such as dust particles.

Also, the thin-film encapsulation layer TFE may further include a buffer layer. The buffer layer may be a layer closest to the sensing unit SU. The buffer layer may be an inorganic layer or an organic layer. The inorganic layer may include at least one of silicon nitride, silicon oxynitride, silicon oxide, titanium oxide, and aluminum oxide. The organic layer may include a polymer, e.g., an acrylic-based organic layer. However, this is merely an example, and the present invention is not limited thereto.

The heating part HP-4 may be disposed below the display panel DP. For example, the heating part HP-4 may be disposed on a rear surface of the base layer BF. The heating part HP-4 may be bonded to the rear surface of the base layer BF.

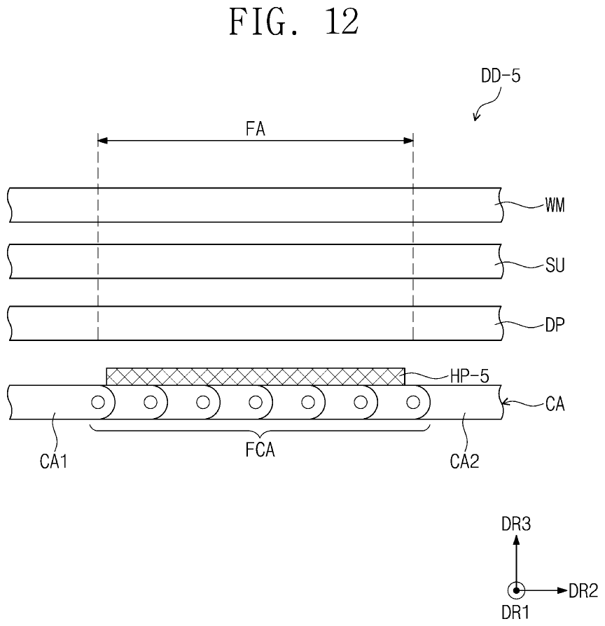

FIG. 12 is a cross-sectional view illustrating partial components of a display device according to another embodiment of the present invention.

Referring to FIG. 12, a display device DD-5 may include a window WM, a sensing unit SU, a display panel DP, a case member CA, and a heating part HP-5.

The case member CA may include a first case part CAL a second case part CA2, and a folding case part FCA. FIG. 12 illustrates a configuration in which the folding case part FCA includes a hinge structure as an example.

The heating part HP-5 may be disposed on the folding case part FCA. For example, the heating part HP-5 may be bonded to the folding case part FCA.

FIG. 13 is a cross-sectional view illustrating partial components of a display device according to still another embodiment of the present invention.

Referring to FIG. 13, a display device DD-6 may include a display panel DP, a case member CA, and a heating part HP-6. The rest components of the display device DD-6 except for the display panel DP, the case member CA, and the heating part HP-6 are omitted in illustration.

The heating part HP-6 may include a first heating part HPa and a second heating part HPb. The first heating part HPa may be disposed on the display panel DP, and the second heating part HPb may be disposed below the display panel DP. That is, the first heating part HPa and the second heating part HPb may be spaced apart from each other in a thickness direction of the display panel DP, e.g., the third direction DR3.

Each of the first heating part HPa and the second heating part HPb may be substantially the same as the heating part HP described in FIGS. 5 and 6. Thus, a detailed description on the first heating part HPa and the second heating part HPb will be omitted.

The first heating part HPa may be disposed at various positions as long as the positions are disposed on the display panel DP. For example, the first heating part HPa may be disposed on the same position as one of positions of the heating parts HP-1, HP-2, and HP-3 described in FIGS. 7 to 9. The second heating part HPb may be disposed at various positions as long as the positions are disposed below the display panel DP. For example, the second heating part HPb may be disposed on the same position as one of positions of the heating parts HP-4 and HP-5 described in FIGS. 11 to 12.

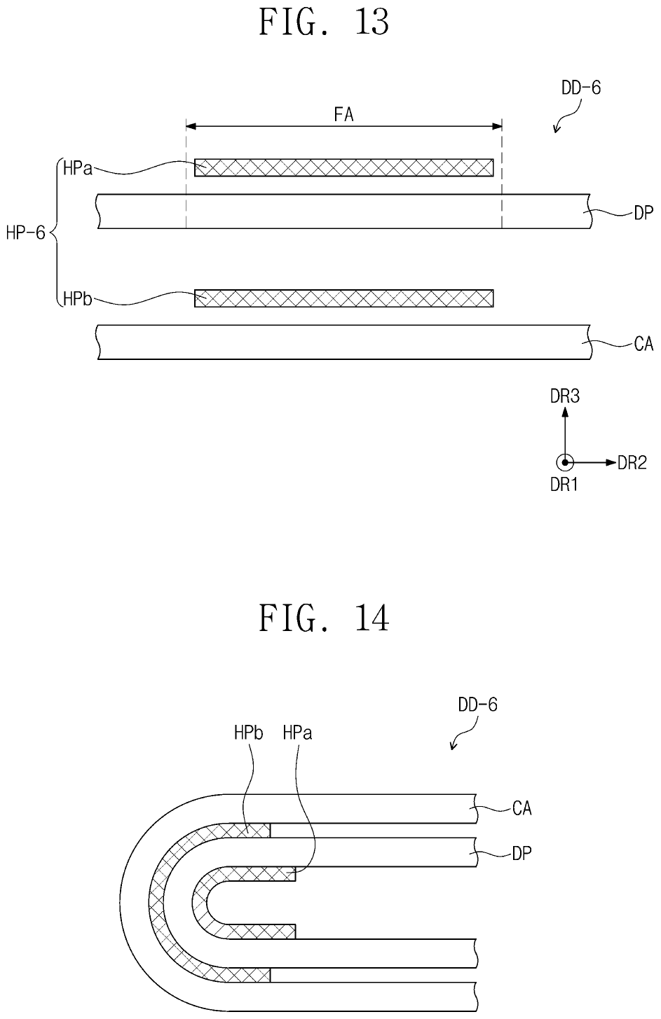

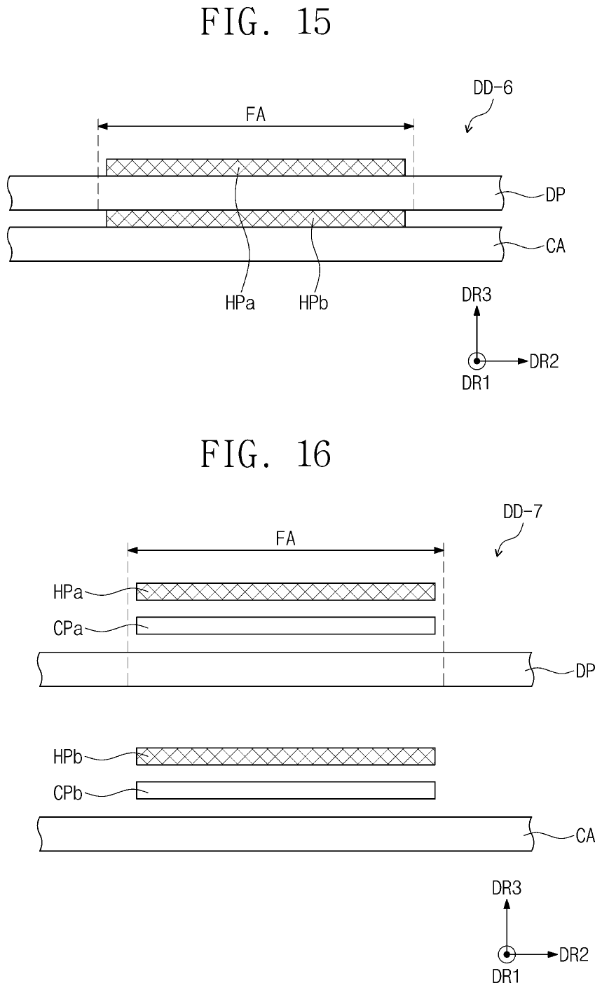

FIG. 14 is a cross-sectional view illustrating a first state of the display device according to an embodiment of the present invention. FIG. 15 is a cross-sectional view illustrating a second state of the display device according to an embodiment of the present invention.

The first state of the display device DD-6 in FIG. 14 may be a folded state of the display panel DP. The second state of the display device DD-6 in FIG. 15 may be an unfolded state of the display panel DP.

When the display device DD-6 is changed from the first state (i.e., folded state) to the second state (i.e., unfolded state), an area adjacent to the first heating part HPa may be expanded, and an area adjacent to the second heating part HPb may be contracted. When changed from the first state to the second state, the first heating part HPa may have a temperature greater than that of the second heating part HPb. For example, when the driving unit (not shown) senses a state change of the display panel DP, a voltage may be provided so that the temperature of the first heating part HPa is greater than that of the second heating part HPb.

When the display device DD-6 is changed from the second state to the first state, the area adjacent to the first heating part HPa may be contracted, and the area adjacent to the second heating part HPb may be expanded. When changed from the second state to the first state, the first heating part HPa may have a temperature less than that of the second heating part HPb.

According to an embodiment of the present invention, the temperature of each of the first and second heating parts HPa and HPb may be adjusted according to the state change of the display panel DP. Thus, as the temperature of the expanded portion increases, a modulus of the expanded portion may decrease, and an elongation and a flexibility thereof may improve.

FIG. 16 is a cross-sectional view illustrating partial components of a display device according to yet another embodiment of the present invention. In describing FIG. 16, the same component as that described in FIG. 13 will be designated by the same reference symbol, and a description thereof will be omitted.

Referring to FIG. 16, a display device DD-7 may further include a first cooling part CPa and a second cooling part CPb. One of the first cooling part CPa and the second cooling part CPb may be omitted. The first cooling part CPa may be disposed on the display panel DP, and the second cooling part CPb may be disposed below the display panel DP. Each of the first cooling part CPa and the second cooling part CPb may overlap the folding area FA of the display panel DP on the plane (i.e., plan view).

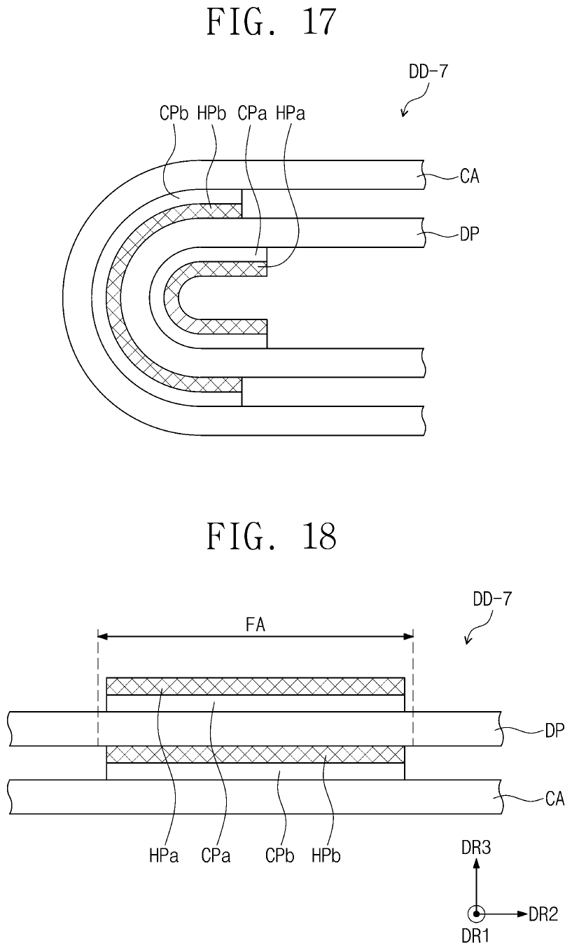

FIG. 17 is a cross-sectional view illustrating a first state of the display device according to an embodiment of the present invention. FIG. 18 is a cross-sectional view illustrating a second state of the display device according to an embodiment of the present invention.

When the display device DD-7 is changed from the first state (i.e., folded state) to the second state (i.e., unfolded state), an area adjacent to the first heating part HPa may be expanded, and an area adjacent to the second heating part HPb may be contracted. When changed from the first state to the second state, the first heating part HPa and the second cooling part CPb may operate.

When the display device DD-7 is changed from the second state to the first state, the area adjacent to the first heating part HPa may be contracted, and the area adjacent to the second heating part HPb may be expanded. When changed from the second state to the first state, the second heating part HPb and the first cooling part CPa may operate.

According to an embodiment of the present invention, whether the first and second heating parts HPa and HPb and the first and second cooling parts CPa and CPb operate may be adjusted according to the state change of the display panel DP. Thus, the heating part disposed adjacent to the portion to be expanded may operate, and the cooling part disposed adjacent to the portion to be contracted may operate.

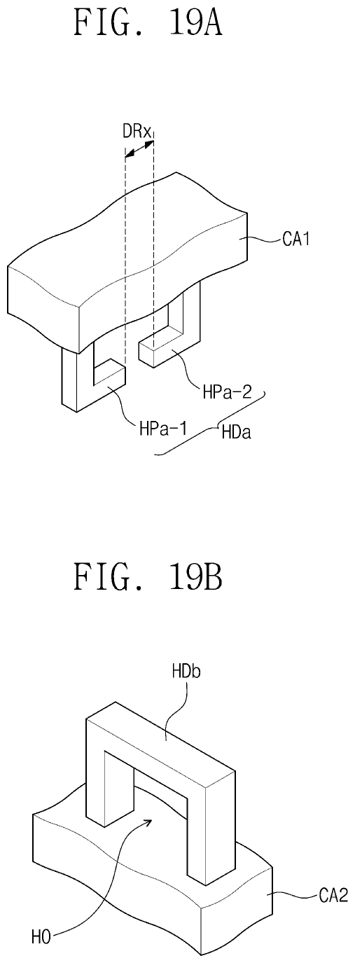

FIG. 19A is an enlarged perspective view illustrating a first fixing part, and FIG. 19B is an enlarged perspective view illustrating a second fixing part.

Referring to FIGS. 19A and 19B, a first fixing part HDa and a second fixing part HDb are illustrated.

The first fixing part HDa may include a first catching part HPa-1 and a second catching part HPa-2. The first catching part HPa-1 and the second catching part HPa-2 may move in a direction DRx to be spaced apart from each other or to be close to each other.

A through-portion HO is defined between the second fixing part HDb and the second case part CA2. When the first catching part HPa-1 and the second catching part HPa-2 are accommodated in the through-portion HO, the first case part CA1 and the second case part CA2 may be coupled to each other. This state may be referred to as a lock state of the case member CA (refer to FIG. 1).

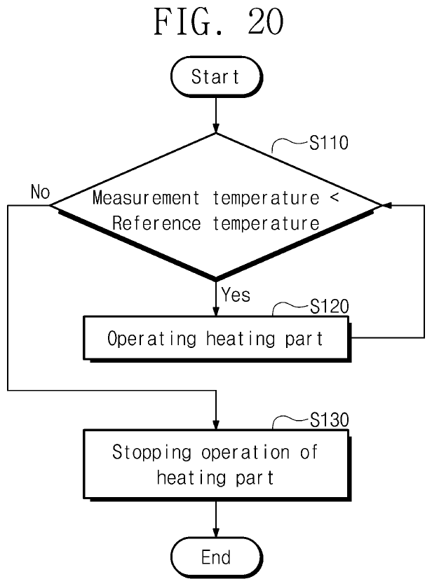

FIG. 20 is a flowchart illustrating a method for controlling the display device according to an embodiment of the present invention.

Referring to FIGS. 5 and 20, the temperature sensor TS measures a temperature. Whether a measurement temperature is lower than a reference temperature is compared in a process S110. Although the reference temperature may be about 0°, the present invention is not limited thereto. A comparison process may be preformed in the driving unit of the display device DD. The driving unit may be a timing controller.

When the measurement temperature is less than the reference temperature, the heating part HP operates in a process S120. The feature in which the heating part HP operates may represent that the heating part HP generates heat as a voltage (i.e., electric power) is provided to the heating part HP.

While the heating part HP generates heat, a temperature may be continuously measured by the temperature sensor TS. When the measurement temperature measured by the temperature sensor TS is equal to or greater than the reference temperature, the operation of the heating part HP may be stopped in a process S130. That is, the heating part HP may not generate heat. In an embodiment of the present invention, when the measurement temperature measured is equal to or greater than the reference temperature from the beginning, the heating part HP may continue to maintain a state not generating heat.

According to an embodiment of the present invention, the display device DD (refer to FIG. 1) may provide a voltage to the heating part HP according to a temperature measured in the temperature sensor. Thus, even when the display device DD is used in a low temperature environment, an area corresponding to the folding area FA may maintain a value equal to or greater than a predetermined temperature by the heating part HP. As a result, when the display device DD is folded or unfolded, a crack may be prevented from being generated in the components of the display device DD, e.g., the window or the display panel.

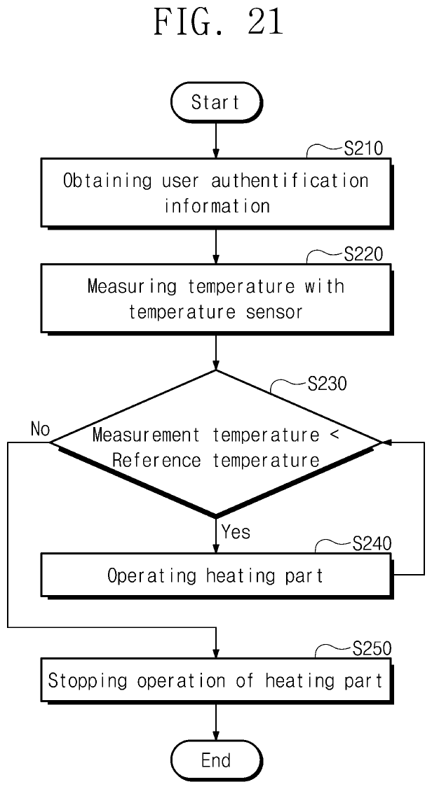

FIG. 21 is a flowchart representing a method for controlling a display device according to an embodiment of the present invention.

Referring to FIGS. 2, 5, and 21, the display device DD may obtain user authentification information in a process S210. The user authentification information may be a fingerprint, an iris, a face, or a blood vessel. However, this is merely an example, and the user authentification information is not limited to the above examples. For example, the fingerprint may be obtained through the fingerprint sensor FPS. The iris and the face may be obtained through the camera CAM. The blood vessel may be obtained through the functional sensor FSS (See FIG. 2).

When the user authentification information is obtained, the temperature sensor TS may measure a temperature in a process S220. Whether a measurement temperature is lower than a reference temperature is compared in a process S230. Although the reference temperature may be about 0°, the present invention is not limited thereto.

When the measurement temperature is less than the reference temperature, the heating part HP may operate in a process S240.

While the heating part HP generates heat, a temperature may be continuously measured by the temperature sensor TS. When the measurement temperature measured by the temperature sensor TS is equal to or greater than the reference temperature, the operation of the heating part HP may be stopped in a process S250.

According to an embodiment of the present invention, the driving unit may determine whether a voltage is provided to the heating part HP according to a temperature of the temperature sensor TS after the user authentification information is obtained. That is, since a voltage is provided to the heating part HP only when the state change of the display device DD is expected, power consumption may decrease.

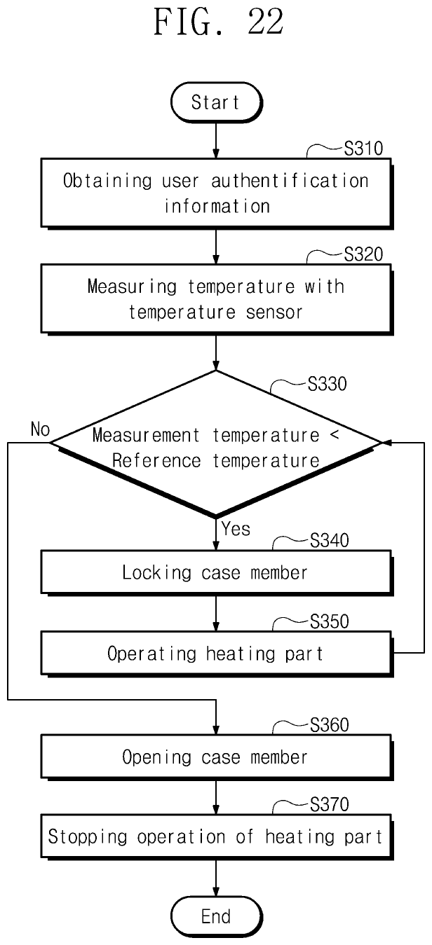

FIG. 22 is a flowchart representing a method for controlling a display device according to an embodiment of the present invention.

Referring to FIGS. 2, 5, and 21, the display device DD may obtain user authentification information in a process S310. The user authentification information may be a fingerprint, an iris, a face, or a blood vessel. When the user authentification information is obtained, the temperature sensor TS may measure a temperature in a process S320. Whether a measurement temperature is lower than a reference temperature is compared in a process S330.

When the measurement temperature is less than the reference temperature, the case member CA may be locked in a process S340. That is, when a crack is expected to be generated in a low temperature condition, the case member CA may not be opened. Since the case member CA is coupled with the display panel DP (refer to FIG. 3), the case member may be referred to as a coupling member. When the case member CA is not opened, a shape deformation of the display panel DP may be prevented.

Thereafter, the heating part HP may operate in a process S350. The heating part HP may receive a voltage and generate heat. While the heating part HP generates heat, a temperature may be continuously measured by the temperature sensor TS. When the measurement temperature measured by the temperature sensor TS is equal to or greater than the reference temperature, lock of the case member CA may be released in a process S360, and the operation of the heating part HP may be stopped in a process S370. Thus, deformation of the display device DD in a low temperature environment may be prevented, and thus a crack may not be generated in the components of the display device.

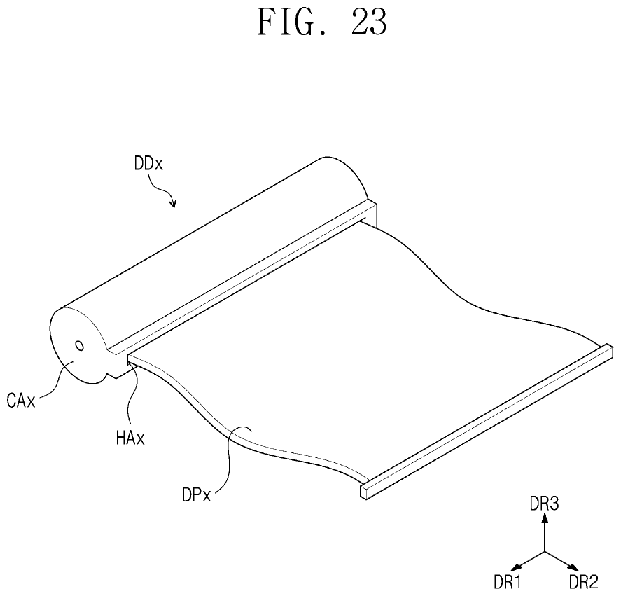

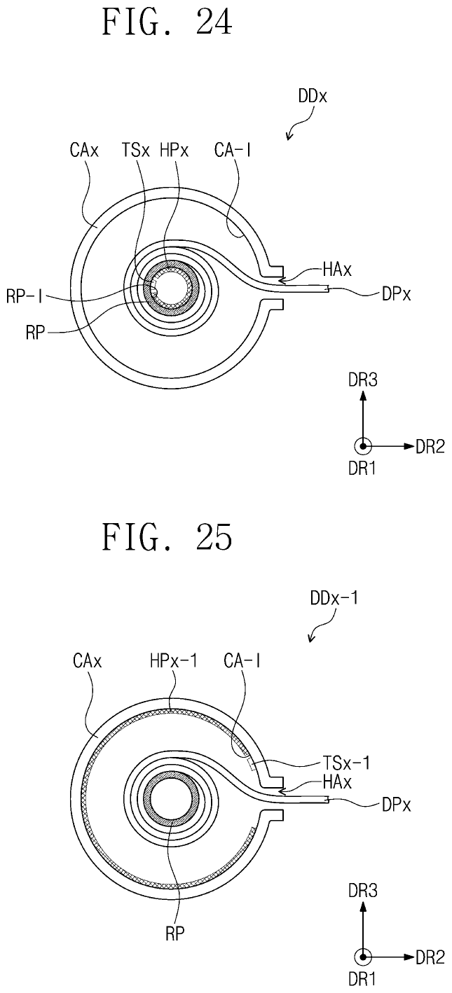

FIG. 23 is a perspective view of a display device according to an embodiment of the present invention. FIG. 24 is a cross-sectional view of the display device according to an embodiment of FIG. 23.

Referring to FIGS. 23 and 24, a display device DDx may be a rollable display device. The display device DDx may include a display panel DPx, a case member CAx, a rotation member RP, a heating part HPx, and a temperature sensor TSx. Even though not illustrated, the display device DDx may further include the authentification sensor described with above embodiments.

The display panel DPx may display an image. The display panel DPx may be wound and stored in the case member CAx. As an external force to roll is applied to the display panel DPx, the display panel DPx may pass through an opening HAx and be exposed to the outside.

The case member CAx may store the display panel DPx therein. Although the case member CAx has an approximately cylindrical shape as an example in FIG. 23, the present invention is not limited thereto. The case member CAx may have various shapes as long as the display panel DPx may be rolled and stored therein.

The rotation member RP may be disposed in the case member CAx. The rotation member RP may be coupled with the display panel DPx to roll or unroll the display panel DPx. Since the rotation member RP is coupled with the display panel DPx, the rotation member RP may be referred to as a coupling member.

A heating part HPx and a temperature sensor TSx may be disposed on an inner surface RP-I of the rotation member RP. Although not shown, a battery, a driving chip, or the like may be additionally disposed in an inner space of the rotation member RP.

The temperature sensor TSx may measure a temperature, and the heating part HPx may operate according to the measured temperature. For example, when a shape of the display panel DPx is deformed (e.g., folded) in a low temperature environment, a crack may be generated in the display panel DPx due to reduced flexibility and lowered modulus. However, according to an embodiment of the present invention, in the low temperature environment, as the heating part HPx operates, the display panel DPx may maintain a temperature range equal to or greater than a predetermined temperature. Thus, a probability of a crack generated in the display panel DPx may decrease.

Also, in an embodiment of the present invention, operation of the rotation member RP may be controlled according to a temperature measured in the temperature sensor TSx. For example, when the measured temperature is less than a predetermined temperature (hereinafter, referred to as a reference temperature), the rotation member RP may be fixed. That is, the rotation member RP may not rotate, and a shape deformation of the display panel DPx in an environment less than the reference temperature may be prevented. As a result, a probability of a crack generated in the display panel DPx may decrease. When the temperature measured in the temperature sensor TSx is equal to or greater than the reference temperature, the rotation member RP may rotate again. Although not shown, the display device DDx may further include a locking device for enabling the rotation member RP to rotate or not to rotate, e.g., a structure such as a catch.

FIG. 25 is a cross-sectional view of a display device according to another embodiment of the present invention.

Referring to FIG. 25, when compared with FIG. 24, a position of each of a heating part HPx-1 and a temperature sensor TSx-1 of a display device DDx-1 is different. The heating part HPx-1 and the temperature sensor TSx-1 may be disposed on an inner surface CA-I of a case member CAx.

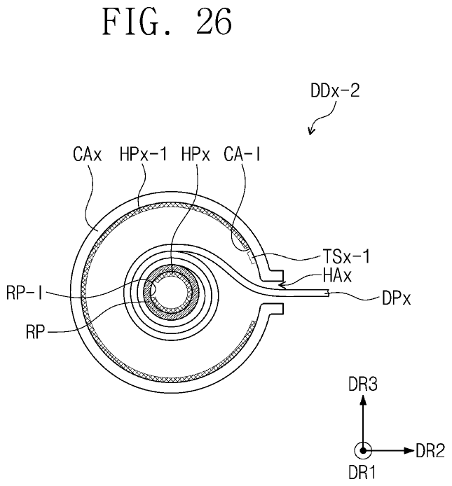

FIG. 26 is a cross-sectional view of a display device according to still another embodiment of the present invention.

Referring to FIG. 26, when compared with FIG. 25, a display device DDx-2 may further include a heating part HPx. As described in FIG. 24, the heating part HPx may be disposed on the inner surface RP-I of the rotation member RP.

It will be apparent to those skilled in the art that various modifications and variations can be made in the present invention. Thus, it is intended that the present invention covers the modifications and variations of this invention provided they come within the scope of the appended claims and their equivalents. Hence, the real protective scope of the present invention shall be determined by the technical scope of the accompanying claims.

### INDUSTRIAL APPLICABILITY

The present disclosure that is intended to secure flexibility and improve durability of a flexible display device has a high industrial applicability.

1. A display device comprising:
a window;
a case member disposed below the window and foldable;
a display panel disposed between the window and the case member and in which a folding area is defined;
a temperature sensor disposed between the window and case member to sense a temperature; and
a heating part disposed on an area which overlaps the folding area in a plan view,
wherein the heating part is configured to operate when a measurement temperature measured in the temperature sensor is less than a predetermined temperature.

2. The display device of claim 1, wherein the window comprises a first window film and a second window film disposed below the first window film, and the heating part is disposed between the first window film and the second window film.

3. The display device of claim 1, further comprising a sensing unit disposed between the display panel and the window and comprising a sensing base layer and a sensing electrode,
wherein the heating part is disposed on one surface of the sensing base layer.

4. The display device of claim 1, further comprising a sensing unit disposed between the display panel and the window and comprising a sensing base layer and a sensing electrode,
wherein the sensing electrode and the heating part are disposed in a same layer.

5. The display device of claim 1, wherein the heating part is disposed on one surface of the display panel.

6. The display device of claim 1, wherein the heating part comprises a first heating part and a second heating part,
wherein the first heating part is disposed on the display panel, and the second heating part is disposed below the display panel.

7. The display device of claim 6, wherein the first heating part has a temperature greater than a temperature of the second heating part when the display panel is changed from a first state that the display device is folded to a second state that the display device is unfolded, and
the first heating part has a temperature lower than a temperature of the second heating part when the display panel is changed from the second state to the first state.

8. The display device of claim 1, further comprising an authentification sensor which obtains authentification information,
wherein the heating part operates according to the measurement temperature when the authentification sensor obtains the authentification information.

9. The display device of claim 8, wherein the case member comprises a locking device, and the locking device locks the case member when the measurement temperature is less than the predetermined temperature.

10. The display device of claim 1, wherein the heating part is a transparent surface heater, and the temperature sensor is a thermistor.

11. The display device of claim 1, further comprising a cooling part disposed on an area that overlaps the folding area in the plan view.

12. The display device of claim 11, wherein the heating part comprises a first heating part and a second heating part, the first heating part is disposed on the display panel, the second heating part is disposed below the display panel,
the cooling part comprises a first cooling part and a second cooling part, the first cooling part is disposed on the display panel, and the second heating part is disposed below the display panel.

13. The display device of claim 12, wherein the first heating part and the second cooling part operate when the display panel is changed from a first state that the display device is folded to a second state that the display device is unfolded, and the second heating part and the first cooling part operate when the display panel is changed from the second state to the first state.

14. A display device comprising:
a case member;
a flexible display panel accommodable in the case member;
a temperature sensor disposed in the case member;
an authentification sensor disposed in the case member; and
a heating part disposed in the case member,
wherein the heating part operates when the authentification sensor obtains the authentification information, and the measurement temperature measured in the temperature sensor is less than a predetermined temperature.

15. The display device of claim 14, further comprising a rotation member disposed in the case member to roll the flexible display panel,
wherein the heating part is disposed in the rotation member.

16. The display device of claim 14, wherein an opening through which the flexible display panel enters is defined in the case member, and the heating part is disposed on an inner wall of the case member.

17. The display device of claim 14, wherein a folding area, a first display area, and a second display area are defined on the flexible display panel,
wherein the first display area and the second display area are spaced apart from each other with the folding area therebetween,
wherein the heating part is disposed adjacent to the folding area.

18. The display device of claim 17, wherein the case member comprises a first case part which supports the first display area, a second case part which supports the second display area, and a lock device which couples the first case part and the second case part,
wherein the lock device locks the first case part and the second case part when the measurement temperature is less than the predetermined temperature in a folded state of the flexible display panel.

19. A display device comprising:
a flexible display panel;
a temperature sensor which measures a temperature;
a heating part which operates according to the measured temperature; and
a coupling member coupled with the flexible display panel and locked when the measured temperature is less than a predetermined temperature.

20. The display device of claim 19, further comprising an authentification sensor which obtains authentification information,
wherein the heating part operates according to the measured temperature when the authentification sensor obtains the authentification information.
